(19) United States
(12) Patent Application Publication
(10) Pub. No.: US 2012/0057600 A1
(43) Pub. Date: Mar. 8, 2012

(54) COOPERATIVE REROUTING

(75) Inventor: Michal Wódcza, Poznan (PL)

(73) Assignee: Telcordia Poland Sp. Z.o.o Applied Research Center, Poznan (PL)

(21) Appl. No.: 13/042,701

(22) Filed: Mar. 8, 2011

Related U.S. Application Data
(60) Provisional application No. 61/311,606, filed on Mar. 8, 2010.

(51) Int. Cl. H04L 12/56

(52) U.S. Cl. 370/400

(57) ABSTRACT

IP Fast Reroute is used as an enabler for cooperative transmission. The combination of IP Fast Re-Route and cooperative transmission reduces the quantity of operations requiring change to another alternative path, particularly in mobile wireless networks characterized by high mobility.

### CROSS-REFERENCE TO RELATED APPLICATIONS

This application claims the benefit of U.S. Provisional Application No. 61/311,606, filed on Mar. 8, 2010 which is incorporated by reference herein in its entirety.

### FIELD OF THE INVENTION

The present invention relates generally to the enhancement of network layer rerouting with the possibility of capitalizing on cooperative paths. Specifically, the invention concerns the exploitation of an added value the alternative paths may have, for the purposes of improving the process of rerouting itself.

### BACKGROUND OF THE INVENTION

The invention is based on the concept of IP Fast Re-Route (Network Layer) and Cooperative Transmission (Link/Physical Layer). The current approaches assume that in case a given path no longer guarantees robust transmission, packets are rerouted over a loop free alternative path. This might involve additional control overhead and network reconfiguration. When cooperative paths exists, a more efficient approach can be used so the transmission is maintained and the above burden related to switching is avoided.

### SUMMARY OF THE INVENTION

A specifically tailored exploitation of Cooperative Transmission can improve IP Fast Re-Routing in terms of reducing the number of unnecessary operations requiring change to an alternative path, which holds true particularly in mobile wireless networks characterized by high mobility.

On the one hand, in wireless networks, the transmission diversity techniques, such as cooperative relaying/transmission, allow more than one intermediary node to assist in the transmission between two other neighbor nodes. Such a process can be further orchestrated with the application of additional routing information. On the other hand wireless networks, characterized by high mobility, require certain level of resilience so that data flow(s) between the end nodes can be maintained. It is necessary that the network instantly reacts to link failures and the currently most efficient approaches assume the use of IP Fast Re-Route. However, as is, IP Fast Re-Route is still not optimal in twits of the overhead related to the fact that switching to an alternative path might be forced in situations where such an operation is not justified because the option of cooperative paths exists. In fact, surplus resilience can be provisioned through the cooperative exploitation of the alternative path(s) together with the current path, where typically only one of the alternative paths would be applied to replace the current one in failure. In other words one can imagine a situation where, based on the current status of a wireless mobile multi-hop network, the Routing Management Decision Element of the Generic Autonomic Network Architecture (GANA) would normally force route change based on the options available from IP Fast Re-Route (IPFRR). However, since information coming from IPFRR can be pre-processed to put the Loop Free Alternative Paths (LFAPs) into cooperative groups, it is still possible that the application of additional logic to the Routing Management Decision Element makes it feasible to keep the connection via a diversified set of multiple paths despite some problems with maintaining non-cooperative (single path) links. In other words, in the worst case none of the potentially available LFAPs may be able to offer decent transmission parameters and the only way to maintain the connection is to put the current path in cooperation with the alternative path(s).

The invention will be better understood when the following description is read in conjunction with the accompanying drawings.

### BRIEF DESCRIPTION OF THE DRAWINGS

FIG. 1 is a schematic diagram of prior art IP Fast Re-Route method.

FIG. 2 is a schematic diagram of a method of IP Fast Re-Route according to the present invention.

FIG. 3 is a schematic diagram illustrating the relationship of IPFRR and TDTNC to GANA Routing Management DE.

FIG. 4 is a graphical representation of Bit Error Rate (BER) thresholds as a function of Signal to Noise Ratio (SNR) for BER=0.001.

FIG. 5 is a graphical representation of Bit Error Rate (BER) thresholds as a function of Signal to Noise Ratio (SNR) for BER=0.005.

FIG. 6 is a graphical representation of Bit Error Rate (BER) thresholds as a function of Signal to Noise Ratio (SNR) for BER=0.010.

### DETAILED DESCRIPTION

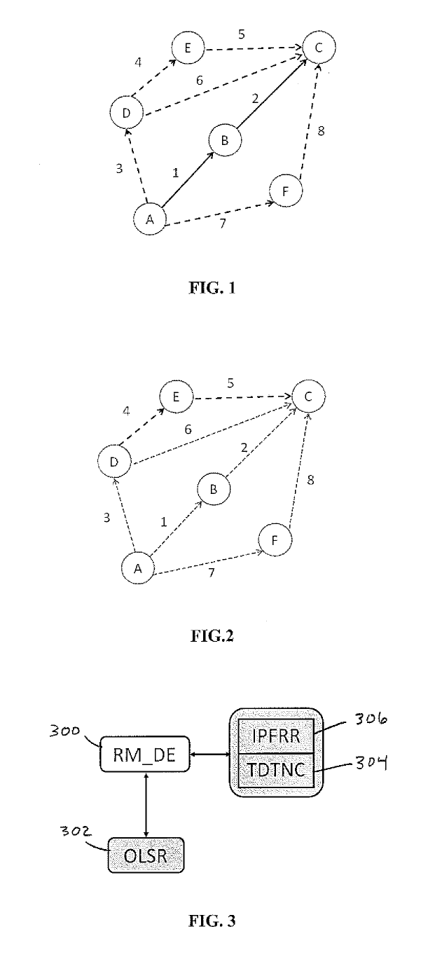

FIG. 1 shows a prior art approach to IP Fast Re-Route. It is assumed here that the packet stream between nodes A and C is normally routed via node B, i.e. the path (1, 2) formed of link 1 and link 2 is used in this example. In case of a failure of link 1 or link 2 or node B the system needs to react and one of the readily available (pre-computed) paths can be used instead immediately. In this case there are the following paths available formed of links (3, 4, 5) or (3, 6) or (7, 8). Any of the loop free alternative paths may be used. The advantage of this approach is that the process of switching to an LFAP is instantaneous, however, this operation still results in some overhead which, depending on the used access technology, may manifest e.g. through the need for additional reconfiguration of some other ongoing transmissions. In the worst case none of the potential LFAPs may be of sufficient quality to maintain transmission.

FIG. 2 depicts a novel method of enhancing IPFRR with the use of cooperative paths when applicable. Cooperative transmission capitalizes on the nature of wireless medium so a packet broadcast by node A is received by nodes B, D and F. Afterwards each of the nodes B, D, and F processes the received signals cooperatively in such a way that they are orthogonal and then synchronously resend the packets towards the destination node C along links (1, 2), (3, 6), (7, 8), respectively. As a result diversity gain is achieved which improves transmission parameters.

The novelty of the present invention is in combining both approaches in a so far never used manner, such that in case the Routing Management Decision Element of GANA observes that a given connection may be lost, it instructs IPFRR to exploit additional, potentially available, cooperative LFAPs.

Such an approach has an advantage related to the specifics of wireless links. Particularly, it is possible to consider a situation where based on the current status of the wireless mobile network the currently employed managing entities would normally force route change based on the options available from IP Fast Re-Route module. However, as a result of using the cooperative transmission it is still possible that the Routing Management Decision Element of GANA orders to maintain the connection with the aid of a diversified set of additional cooperative paths chosen to support the current single path in question.

The Routing Management Decision Element (RM_DE) receives directions from the Transmission Diversity Through Node Cooperation (TDTNC) module as shown in FIG. 3. This way node cooperation can be actually exploited in advance of a failure, during normal transmission, as an inherent feature of IPFRR. In particular, this concept is especially applicable for dense set-ups, i.e. in cases where there exist additional nodes that can form redundant paths of the same length (in terms of the number of hops) between the source and destination.

One should also note that there is a significant difference between TDTNC and ECMP (Equal-Cost Multi-Path Algorithm) due to the fact that TDTNC is based on interactions with physical and link layers. While in general ECMP is aimed at helping with load balancing, TDTNC improves robustness through the thoughtful use of cooperative transmission.

The integration between the IP fast re-rerouting and transmission diversity through node cooperation has been done as an extension to the framework of Generic Autonomic Network Architecture (GANA) through the incorporation of certain logic supporting the operation of the Routing Management Decision Element (RM_DE) 300. In fact, the node level RM_DE is assumed to function at particular nodes and steer the behavior of the network layer protocol, Optimized Link State Routing protocol, OLSR 302 through the interaction with TDTNC 304 and IPFRR 306 as shown in FIG. 3. At this point other aspects might be taken into account such as auto-configuration, survivability, fault-management, not excluding some policies imposed by the network operator.

It should be noted that TDTNC entity first needs to analyze information about LFAPs coming from IPFRR module to check if cooperative node(s) can be used for a given topology. Since the focus is on MANETs and the topology is changing this is a continuous process. Once a decision has been made the applicable LFAPs are enabled while there may still exist some other “non-TDTNC” compliant paths as well. It means that as long as the criteria for successful transmission are met the “cooperative” LFAPs are used and then the system might switch to another LFAP or even a group of LFAPs being able to form another “cooperative” group. Such an approach has an advantage related to the aforementioned specifics of wireless links. The employment of TDTNC may help in avoiding given links being classified of a too low quality because, as indicated before, diversity is a known method for mitigating the impairments of wireless channel. That is why it is possible to think about a situation where based on the current status of the wireless mobile multi-hop network the current solutions would normally force route change based on the options available from IPFRR, but thanks to the fact that some of the information coming from IPFRR has been pre-processed by TDTNC, the RM_DE it is still able to keep the connection via a diversified set of paths despite some problems.

The role of RM_DE is two-fold—firstly, it needs to take into account any policies imposed by the network operator, and secondly its role is to make sure that information about LFAPs can be used as so on as there are symptoms available, indicating an imminent link failure. This is where the proposed solution comes into play to increase system robustness and resilience.

As described in the algorithm below, both the links between the source (x) and relay (n), as well as between the relay (n) and the destination (n²) need to be checked and depending on whether both of them can offer the requested quality or one of them is not, further steps are taken. The case of interest is the latter one. In that situation the algorithm needs to check whether there exist any group of nodes that would be able to cooperatively support transmission. If there exist cooperative LFAPs then the corresponding set of nodes is referred to as a virtual antenna array VAA between the source and destination. The following is an algorithm for Fast Re-Route and Node-to-Node Cooperation.

| | |
|---|---|
| 1: | if ((x, n) < θ or (n, n²) < θ) then |
| 2: | if VAA(x, n⁽²⁾) ≠ θ) then |
| 3: | route_cooperatively(VAA(x, n⁽²⁾)) |
| 4: | else |
| 5: | fast_reroute((x, n⁽²⁾) |
| 6: | end if |
| 7: | end if |

If a given VAA set is valid it is so that data may be routed cooperatively over multiple paths using the gains described below summarising the simulation results. Otherwise, it is necessary to start rerouting.

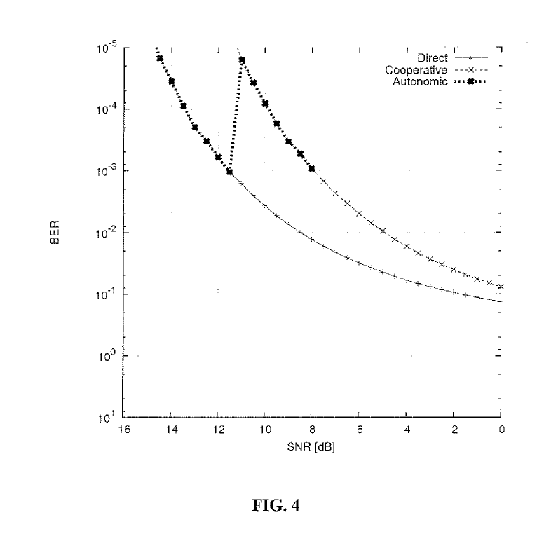

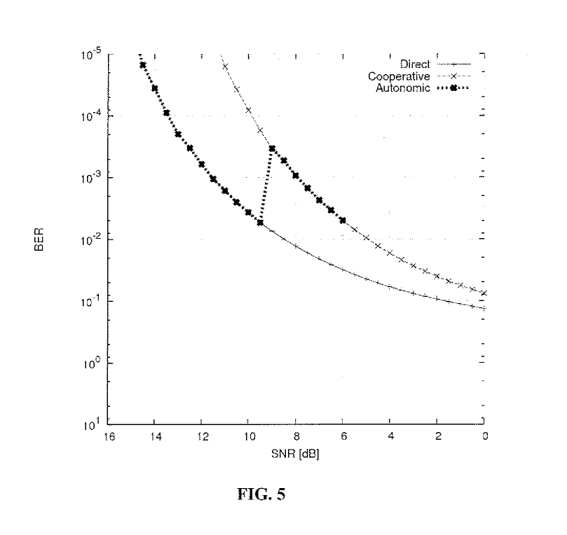

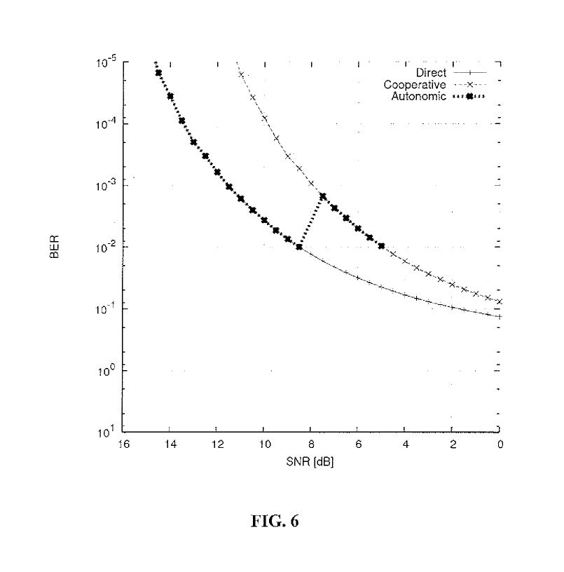

To validate this approach a series of simulation evaluations has been performed. FIG. 4, FIG. 5 and FIG. 6 show that for given Bit Error Rate (BER) thresholds, it is advantageous to use the proposed approach and switch from non-cooperative transmission to the cooperative one using a cooperative LFAPs. This way gain in Signal to Noise Ratio (SNR) is obtained, avoiding the necessity of choosing another non-cooperative LFAP.

The corresponding results for BER=0.001 are shown in FIG. 4, for BER=0.005 are shown in FIG. 5, and for BER=0.010 are shown in FIG. 6.

While there has been described and illustrated a system and method using cooperative rerouting, it will be apparent to those skilled in the art that modifications and variations are possible without deviating from the teachings and broad principles of the invention which shall be limited solely by the scope of the claims appended hereto.

What is claimed is:

1. A method of transmitting from a source node to a destination node comprising using IP fast re-route and cooperative transmission.
